(19) United States
(12) Patent Application Publication
(10) Pub. No.: US 2026/0304276 A1
(43) Pub. Date: Oct. 1, 2026

(54) SYSTEMS AND METHODS FOR MANAGING USER CONNECTIVITY AND TRANSITION BETWEEN WIRELESS LANS AND MOBILE NETWORKS

(71) Applicant: Adeia Guides Inc., San Jose, CA (US)

(72) Inventors: Dhananjay Lal, Englewood, CO (US); Christopher Phillips, Hartwell, GA (US); Ning Xu, Irvine, CA (US); Tao Chen, Palo Alto, CA (US)

(21) Appl. No.: 19/092,152

(22) Filed: Mar. 27, 2025

(51) Int. Cl. H04W 36/32; H04B 7/06; H04B 17/318; H04W 64/00

(52) U.S. Cl. CPC H04W 36/32; H04B 7/0626; H04B 17/328; H04W 64/006

(57) ABSTRACT

Channel state information (CSI) of a communication link with a mobile device, such as a cellular telephone, may be measured and used to determine whether the mobile device is within an egress/ingress zone of premises served by a Wi-Fi Access Point (Wi-Fi AP). If a trajectory of the mobile device at or near the egress/ingress zone is determined to indicate that the mobile device is leaving the premises, then a handoff of the mobile device to a transceiver of a second telecommunications network, such as a cellular network base station (BS), may be initiated. Various triggers, such as RSSI, may be used to decide whether CSI measurement is to be initiated.

### BACKGROUND

This disclosure is directed to determining to hand off device network connectivity from one network to another and, in particular, to handoff network connectivity of a mobile device between a Wi-Fi local area network (LAN) access point and a transceiver of another telecommunications network (e.g., a mobile network).

### SUMMARY

A technological problem that arises for a mobile or portable device (sometimes referred to as a PD), such as a mobile phone (e.g., a smartphone) that is connected to a network is determining when it is to time to switch to a different network. For example, the PD's communication with a Wi-Fi access point (sometimes referred to as a Wi-Fi AP or as an AP) may begin to become attenuated as the PD moves farther from the AP. The PD may thus be better served by handoff (also known as handover) to a local base station (sometimes referred to as a BS) of a cellular telecommunications network, to some other telecommunications network (e.g., a satellite communication network), or to a second Wi-Fi AP associated with another Wi-Fi network.

In some approaches, handoff of the PD between the AP and the BS occurs when it is detected that a received signal strength indicator (sometimes referred to as RSSI) is below a threshold or when some other quality of service (sometimes referred to as QoS) parameter is determined. However, waiting for the time that the RSSI or QoS reaches this threshold, or indicates such a parameter, and then initiating the handover process, may result in the system waiting too long before handoff is initiated. This may result in an undue deterioration of user quality of experience (sometimes referred to as QoE, which may be measured by such metrics as bandwidth/throughput, latency, jitter, reduced ABR bitrate, dropped packets, dropped calls, or the like). Moreover, during such waiting time, computing and/or network resources may be fruitlessly expended by networking devices and/or the client device in attempting to utilize a network that is minimally performant or non-performant.

A related technological problem is sometimes known as the “sticky client” problem, such as when the client “sticks” to an in-home Wi-Fi network rather than transitioning to a mobile network in a timely manner, such as when the user steps out of the home with their mobile device. For example, a PD (in this case the “client”) may continue to be served by the AP delivering sub-optimal QoE even if the BS would be capable of delivering superior QoE. This problem may be pronounced when the PD continued to communicate with the Wi-Fi AP because of policies that favor decentralized administration of the AP. In one approach, techniques such as client-steering, i.e., letting the client choose the best AP, have been employed in an effort to address these limitations. Mobile network operators (sometimes referred to as MNOs) may prefer to offload traffic from cellular telecommunications networks to Wi-Fi networks to reduce their own operating costs. Also, indoor coverage by cellular networks is challenging for 5G millimeter wave (mmWave) frequencies in microwave bandwidths. For these reasons, a “Wi-Fi First” approach may be used: prioritize Wi-Fi connection over cellular connection whenever the PD can access an available Wi-Fi network. When the PD is thus offloaded to the extent possible to the Wi-Fi network, transition from Wi-Fi to cellular may cause challenges because the PD may stay connected to the Wi-Fi network even when the Wi-Fi network quality is poor. An example of such delays that may be caused by the “sticky Wi-Fi” issue is shown in FIG. 6.

To help address these issues, according to aspects of some embodiment of the disclosure, systems and methods are disclosed to provide improved transitions of a mobile device's network connection between, e.g., a Wi-Fi LAN and mobile telecommunications networks. For example, such transition may be made smoother and more efficient, and a duration of a poor QoE during the transition may be mitigated. Moreover, expenditure of network and/or computer resources in relation to a minimally performant or non-performing network may be reduced, in favor of more effective utilization of such resources. In some embodiments, the handoff system may use wireless signal characteristics, such as, Channel State Information (CSI), for example, as derived from the Wi-Fi chipset of the AP (e.g., a gateway, modem, and/or router in a location in which the wireless LAN is provided) and/or from the mobile device and/or from the local BS, to infer that a user is moving out of (and/or that the user intends to move out of) a location (e.g., a home of the user) at which the AP is located. A signature associated with an egress/ingress zone may be determined based on the CSI and may be used as a trigger to make an immediate determination about movement of the mobile device (e.g., determine a trajectory of the mobile device in a direction away from the AP, toward or beyond a portion of the egress/ingress zone remote from the AP, and/or away from indoor space), initiating a handoff action for the mobile device. Such a handoff action may include one or more of switching off (e.g., temporarily) Wi-Fi to force a switch to the cellular connection, signaling underlying communication drivers to perform traffic steering or traffic switching to the cellular network, and/or signaling the BS to manage communication with the portable device. In some embodiments, the disclosed systems and methods may utilize the CSI to determine that a device is in an egress zone, plus its trajectory of movement, and the device subsequently switches/steers its traffic to cellular upon determination of user intent.

Described herein is a method, system, device, non-transient computer readable medium, and means for carrying out the method for determining to initiate a handoff action. A method includes: determining channel state information (CSI) of a communication link with a portable device, wherein the communication link is provided at least in part by a Wi-Fi Access Point (AP) associated with a first telecommunications network or a transceiver of a second telecommunications network; based at least in part on the determined CSI, determining that the portable device is at an egress/ingress zone; detecting a direction of movement of the portable device at or near the egress/ingress zone; based at least in part on the detected direction of movement of the portable device and based at least in part on the determining that the portable device is at the egress/ingress zone, initiating an action for handoff of the portable device between the AP and the transceiver of the second telecommunications network.

Such a method may also entail: determining that a networking related signal strength of a signal received at or transmitted by the portable device is weakened, wherein the determining of the CSI of the communication link with the portable device is initiated based at least in part on the determining of the weakened signal strength. Other ways of triggering initiating the determination of the CSI of the communication link with the portable device may include one or more of: determining that a quality of a networking related signal received at or transmitted by the portable device has deteriorated; detecting a network traffic speed decrease at the portable device; receiving an indication of a timeout metric or a lost application layer packet metric; detecting a download speed at the portable device based at least in part on an adaptive bit rate (ABR) ladder setting; detecting a proximity of the portable device to a second device; mapping a plurality of physical locations in relation to the Wi-Fi local area network, such that the determining of the CSI of the communication link with the portable device is initiated based at least in part on detecting that the portable device is in a first physical location of the plurality of physical locations.

Using such a method, the determining that the portable device is at the egress/ingress zone may include determining a CSI signature at a physical location of the portable device. The determining the CSI of the communication link with the portable device may be performed by the AP of the Wi-Fi local area network. Further, the direction of the movement of the portable device may also be determined based at least in part on the CSI.

The second telecommunications network may be a mobile network, and the determining the CSI of the communication link with the portable device may be performed by a base station of the mobile telecommunications network.

A position of the portable device may be determined based at least in part on inertial measurement unit data generated by the portable device. For example, the direction of the movement of the portable device may be detected based at least in part on the detected position of the portable device.

The system may perform one or more actions for handoff, for example, signaling a portable device traffic switch from the AP to the transceiver of the second telecommunications network; switching off Wi-Fi communication for the portable device; traffic steering, switching or splitting across networks.

Based at least in part on the detected direction of movement of the portable device and based at least in part on the determining that the portable device is at the egress/ingress zone, the system may notify a second portable device (e.g., a smartwatch worn by the user holding the portable device) of the handoff. The system may notify a second portable device of the action for handoff (or notify it of an imminent handoff) based on detecting that the second device has a similar direction of movement to the portable device. The system may also initiate a handoff action for the second portable device.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 illustrates a Wi-Fi AP located in a premises and one or more egress/ingress zones in which a mobile device may be present, according to an example of an aspect of some embodiments of the present disclosure;

FIG. 2 illustrates communication channel or link between a transmitter and a mobile device and a CSI measurement to determine location, according to an example of an aspect of some embodiments of the present disclosure;

FIG. 3 illustrates a wireless parameter matrix with the channel characteristics or characteristics generated based on the input signal, according to an example of an aspect of some embodiments of the present disclosure;

FIG. 4 illustrates a process for Wi-Fi AP determination, according to an example of an aspect of some embodiments of the present disclosure;

FIG. 5 illustrates steps that may be taken prior to determining to switch the PD 105 from a Wi-Fi network to a mobile telecommunications, according to an example of an aspect of some embodiments of the present disclosure;

FIG. 6 is a table illustrating delays that may be caused by the “sticky Wi-Fi” issue, according to other approaches;

FIG. 7 determination for handoff of mobile device communication between a Wi-Fi AP and a second network, according to an example of an aspect of some embodiments of the present disclosure;

FIG. 8 illustrates CSI measurement triggered based on RSSI, according to an example of an aspect of some embodiments of the present disclosure;

FIG. 9 illustrates CSI measurement triggered based on application input, according to an example of an aspect of some embodiments of the present disclosure; and

FIG. 10 illustrates CSI measurement triggered with Wi-Fi AP assistance, according to an example of an aspect of some embodiments of the present disclosure;

FIG. 11 illustrates CSI measurement triggered with assistance from a second Wi-Fi-enabled device, according to an example of an aspect of some embodiments of the present disclosure;

FIG. 12 illustrates CSI measurement triggered based on traffic speed, according to an example of an aspect of some embodiments of the present disclosure;

FIG. 13 illustrates CSI measurement triggered based on ABR video playout for reporting speed estimation, according to an example of an aspect of some embodiments of the present disclosure;

FIG. 14A illustrates CSI measurement triggered based on low latency video delivery for reporting bandwidth, according to an example of an aspect of some embodiments of the present disclosure;

FIG. 14B illustrates a low latency video player, according to an example of an aspect of some embodiments of the present disclosure;

FIG. 15 illustrates a notification for confirming movement from the premises, according to an example of an aspect of some embodiments of the present disclosure;

FIG. 16 illustrates a process for determining initiation of an action for handoff, according to an example of an aspect of some embodiments of the present disclosure;

FIG. 17 illustrates a computer device for implementing methods described herein, according to an example of an aspect of some embodiments of the present disclosure;

FIG. 18 illustrates a computing device communicating via a network, according to an example of an aspect of some embodiments of the present disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

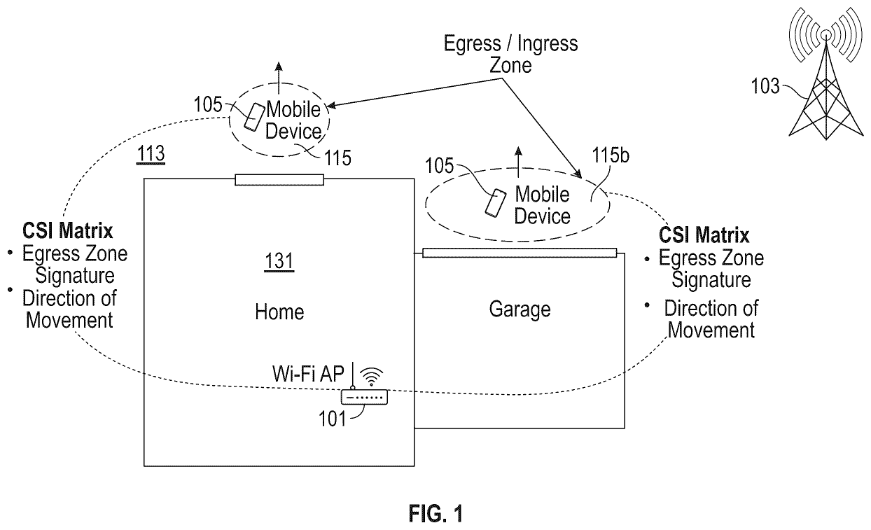

FIG. 1 illustrates an example of some embodiments with one or more identified egress/ingress zones 115, 115b, in accordance with some embodiments of this disclosure. In some embodiments, a handoff system may comprise any suitable combination of hardware and/or software to provide the functionalities described herein. Handoff may be a process of transferring an ongoing call or data session from one channel (e.g., a radio link provided by the Wi-Fi AP 101) connected to the core network to another channel (e.g., a cellular or other telecommunication network). It may entail transferring without undue loss of information or interruption. In some embodiments, egress/ingress zone 115 may be identified by a network AP, such as, for example, a Wi-Fi AP 101 associated with a first telecommunications network, by other networking equipment (e.g., a backbone or carrier router), devices or servers associated with the first telecommunications network, by a mobile device 105 and/or by a mobile telecommunications network BS 103, and/or by any other suitable device or component, in accordance with some embodiments of this disclosure. Such networks, devices and components, and/or any suitable portions thereof, may be considered as being implemented at least in part by the handoff system. In some embodiments, the handoff system may be implemented at least in part by streaming, cable, Internet of things (IoT) providers, home security and automation providers, Internet service providers (ISPs), Wi-Fi management applications, mobile telecommunication network operators, and/or other telecommunication network operators.

In some embodiments, the first telecommunications network provides, for example, broadband Internet provided at least in part by an ISP. The first telecommunications network may include, for example, any suitable software and/or hardware (e.g., networking equipment, servers, and/or databases) and/or any suitable infrastructure (e.g., physical cable transmission lines, fiber-optic transmission channels or mediums or channels, satellites) to provide core, regional, access networks and/or backhaul (and/or any other suitable portion of the network) of one or more Internet service providers (ISPs), to facilitate a telecommunications network. In some embodiments, the ISP may be provided by a business or other organization that provides access to the Internet for a fee. For example, the first telecommunications network may provide a WAN, to facilitate Internet connectivity (or connectivity over any other suitable public or private network) between networked devices worldwide or over any other suitable geographic region or location(s), to enable such devices to exchange information and resources. In some embodiments, a WAN or service provider network 102 may be used to connect LANs (and/or other types of communication) to enable electronic communications between remotely located devices. The LAN may be a small-scale network for data exchange between a group of computers or other devices at a single location, provided at location 131 by way of AP 101,

The second telecommunications network may be, for example, a mobile telecommunications network (e.g., a cellular network) or a satellite network, The mobile telecommunications network may utilize any suitable infrastructure (e.g., cell towers and other components of the radio access network [RAN]), hardware, and software to provide mobile network connectivity between devices. an ad hoc arrangement of nodes communicating via of radio frequency, and/or may utilize (at least in part) a second Wi-Fi AP, and/or may be any other suitable network.

Network AP 101 may be, for example, a modem, router, switch, gateway, wireless access point, mesh access point, extender, hub, any other suitable networking equipment, and/or any suitable combination thereof. While network AP 101 is shown as a Wi-Fi AP, network AP 101 may be configured to operate as an AP for any suitable type of wireless network protocol. While location 131 is shown as a home of a user, location 131 may be any suitable location, sometimes referred to as premises, e.g., a place of business, a school, a public library, an entertainment complex, hotel, or any other suitable location. In some embodiments, network AP 101 may be configured to forward or route data packets from the Internet connection, received by way of a modem, to devices within the localized network and receive data packets from such devices. In some embodiments, the router may include a built-in modem to provide access to the Internet for the household (e.g., received by way of cable or fiber connections included in backhaul portions of a telecommunications network), built-in switches or hubs to deliver data packets to the appropriate devices within the Wi-Fi network, built-in APs to enable devices to wirelessly connect to the Wi-Fi network, and/or the handover system may include one or more stand-alone modems, switches, routers and access points. In some embodiments, network AP 101 may be leased from and/or installed at location 131 (e.g., the customer's premises) by the ISP as part of a managed Wi-Fi install, to give the ISP visibility into LAN and WAN network traffic associated with data transmitted to or receive from network AP 101.

The egress/ingress zone 115 is represented by its location, for example, just outside indoor spaces of the premises, based on a location signature captured based at least in part on wireless signal characteristics. For example, the wireless signal characteristics may be based at least in part on Channel State Information (CSI) metrics, e.g., a CSI matrix. In some embodiments, the wireless signal characteristics may be based at least in part on RSSI and/or received channel power indicator (RCPI). For example, network AP 101 may be equipped with MIMO (Multiple Input Multiple Output) technologies, e.g., MIMO-orthogonal frequency-division multiplexing (OFDM), multi-user MIMO enabling multiple devices to communicate with network AP 101 simultaneously, or single-user MIMO, which may provide CSI for each corresponding set of transmit and receive antennas for particular carrier frequencies (e.g., as between antennas of network AP 101 and antennas of the mobile device). Wireless signals may propagate from the transmitter to the receiver at certain carrier frequencies along multiple paths, and a time series of CSI measurements capturing how wireless signals travel through surrounding objects and humans in time, frequency, and spatial domains may be determined, and subsequent changes in that landscape may be determined, e.g., based on the way the RF energy is absorbed or reflected, which may correlate with someone or something being present or not present, and/or moving or being stationary.

In some embodiments, while the mobile device 105 is moving through the egress/ingress zone 115, a direction of movement may also be identified. The handoff system may identify that the mobile device 105 is in an egress/ingress zone 115 using the location signature derived from the CSI matrix. Further, the handoff system may identify a direction of movement from the CSI matrix, and/or using data provided by an inertial measurement unit (IMU) to determine angular velocity and/or linear acceleration along multiple axes of motion. Based on such information, the handoff system may determine that, with the current movement direction, mobile device 105 is moving through, will be moving through, or has moved out of or into the egress/ingress zone 115. For example, such information may be indicative that (and lead to an inference that) the user is leaving the home premises. The handoff system may respond to this event by forcing the Wi-Fi connection to terminate or forcing the traffic to switch or steer to the cellular connection, which may mitigate the poor user experience duration and helping avoid expenditure of resources in relation to a minimally performant or non-performant network. In some embodiments, the egress/ingress zone 115 is just outside location 131, e.g., the zone may be fingerprinted well due to the multipath fading derived from indoor signals, albeit it is typically still within home Wi-Fi range.

The receiver of a radio transmission may capture information regarding the wireless channel. For example, the receiver may be the PD 105, the Wi-Fi AP 101 or the BS 103, or any other suitable device. Unlike wired communication, wireless signals travel in a rich scattering environment. Wireless signals are reflected, refracted and diffracted before reaching the receiver device. Due to the different paths available from transmitter to receiver, the signal is said to propagate in a multi-path environment. As a result of a muti-path transmission path for the wireless signal, the transmitted signal undergoes change due to local conditions before being received at the receiver. For example, the following transformation may be applied:

$$R = H \times T + n ,$$

where R is the received signal,
T is the transmitted signal,
H is the channel transformation matrix,
n is the noise caused by components in the receiver path, and
H corresponds to the impact of the multi-path wireless transmission medium.

Channel sounding and other methods may be used on the receiver side to estimate the channel parameter H. The channel parameter H depends on the wireless medium. If the wireless medium changes, this will change the channel parameter H. Wireless channel sounding and processing of parameter values in such a method is discussed in more detail in U.S. Patent Application Publication 2021/0011108 published Jan. 14, 2021 and entitled “Method and system for direction finding and channel sounding using pseudo-doppler antenna array,” the entire contents of which are incorporated herein by reference, discloses a channel sounding method. Successive Interference Cancellation (SIC) may be used to estimate CSI when Non-Orthogonal Multiple Access (NOMA) is used in wireless 5G networks.

Wireless signals have also been used to detect motion. For example, U.S. Pat. No. 10,742,475 (entitled “Method, apparatus, and system for object tracking sensing using broadcasting”) and issued Aug. 11, 2020, the entire contents of which are incorporated herein by reference, describes that wireless receivers can receive the series of probe signals through the wireless multipath channel between the heterogeneous target wireless receiver and the transmitter, and obtain time series of channel information (TSCI) of the wireless multipath channel based on the series of probe signals received. An object associated with the heterogeneous target wireless receiver can then be tracked based on the at least one TSCI. Changes in channel information, called time series channel information (TSCI), is tracked to detect motion. If there are abnormal changes to the TSCI, then motion is understood to have happened. Machine learning algorithms may be used in conjunction to detect the type of motion that has occurred (e.g., human vs. animal).

The transmission signal may be previously stored and may be used each time a signal signature is to be obtained at the receiving side for estimating the channel characteristics. The transmission signal may be designed as a series of wireless signals, for example, signals transmitted on several radio frequencies over a period of time. More than one antenna may be used by the signal transmitter to provide the transmission signal. According to an aspect of the disclosure, the consistent use of a single transmission signal pattern may facilitate signal processing at the receiving side to identify the signal signature in the received signal.

Some wireless frequencies may enter surfaces more deeply or more readily than others, and while other frequencies, such as shorter wavelength frequencies, would tend to scatter more readily than other frequencies. A signal receiver then captures the transmission signal thus scattered as an input signal. While sometimes described as a signal receiver in the singular, it is to be understood that the signal receiver may comprise two or more antennas to capture different frequencies and that the signal receiver may comprise several wireless receivers positioned separately in, on or in proximity to the AP and/or the portable device.

The input signal may be processed using known signal processing techniques to obtain wireless channel characteristics. Signal channel sounding techniques may be used to identify parameter values associated with the channel, including frequency and timing of the components of the transmission signal, and these may be compared with corresponding parameter values of the known transmission signal. A controller may control both the wireless transmitter and the wireless receiver and thus ensure that the transmission signal is known when the input signal is processed. One or more matrices of signal parameter values may be assembled based on the signal channel sounding processing.

Typically, a machine learning-based embedding technique may be used to identify a signal parameter pattern within the matrices of values thus obtained. In a training phase, machine learning techniques may be used to train a machine learning model to identify signal patterns within the parameter values of the input signal that identify an ingress/egress area. For example, the ingress/egress area may be an area just outside an indoor place proximate the Wi-Fi AP 101. The ingress/egress zone 115 may be determined by its position relative to CSI features of an indoor space, and thus the ML model would be trained to be able to pick out an ingress/egress zone adjacent the building in which the Wi-Fi AP 101 is located. A pattern of parameter values corresponding to the ingress/egress area 115 may be saved as the signal signature of the ingress/egress area 115. This signal signature may then be compared to signal signatures obtained in future sessions to identify the ingress/egress area. In some embodiments, the transmission signal may be identical each time CSI is initiated so that the second signal signature thus obtained could be compared against previously stored signal signatures for ingress/egress area.

The egress/ingress zone 115 may be part of an adjacent area 113 just outside the home (an indoor structure with the AP 101 where the mobile device 115 was just located). The egress/ingress zone 115 may be identified as having a signal signature adjacent an indoor signal where multipath fading is determined (CSI fingerprinting localization is challenging for open space environments) but still within the AP range. That is, the signal signature may be determined based at least in part on observed relationships between known characteristics of transmitted signals (e.g., transmitted by one or more transmitters) and observed characteristics of received signals, sometimes referred to as the input signal (e.g., the signal received by one or more receivers—signals transmitted by the Wi-Fi AP 101 and received by the PD 105 or signals transmitted by the PD 105 and received by the Wi-Fi AP 101), by analyzing transmitted signals and corresponding received signals. The signal signature may be stored to memory as a known signature linked to the egress/ingress zone 115. In some implementations, the CSI may be measured based on the state of the communication channel between the PD 105 and the BS 103, or based on the state of the communication channel between the PD 105 and a satellite station or a second Wi-Fi AP associated with another Wi-Fi LAN.

In some embodiments, the signal signature may be generated by transmitting multiple transmission signals, observing multiple received signals, and identifying multiple corresponding CSI sets or CSI matrices. The signal signature may be generated by feeding each of these multiple CSI sets or CSI matrices to a trained machine learning model (sometimes referred to as an MIL, model). After a known signature or signatures has been stored to memory for the egress/ingress zone 115, the handoff system may determine presence at (or near) the egress/ingress zone 115 by acquiring a candidate signal signature and determining whether or not it sufficiently matches or corresponds to the known signal signature that was previously stored. Because the egress/ingress zone 115 has a distinct signal pattern, when a common set of transmission signals is transmitted, the characteristics of the received signals and the resulting CSI or CSI matrix will be distinct from other areas covered by the LAN (e.g., due to different signal reflection and refraction in indoor areas).

The CSI may be computed continuously to determine whether the PD 105 has entered the egress/ingress zone 115 and, if so, has a direction of movement away from the AP 101. Such calculation for trajectory of movement may be determined or may be augmented with sensory input from an IU for linear acceleration and angular velocity along multiple axes of motion. If all the conditions are met, then an action may be requested for handing off the PD 105 from the AP 101 of the LAN to the BS 103 of the cellular telecommunications network.

In some embodiments, handoff may be from the BS 103 to the AP 101, from a second AP to the Wi-Fi AP 101, or from a satellite station to the Wi-Fi AP 101. If the PD 105 is communicating with the BS 103 and is determined to have entered or to be near the egress/ingress zone 115, a trajectory of the PD 105 may be determined to be toward the AP 101, toward an indoor space 131 toward an area of the egress/ingress zone 115 proximate the AP 101 or the indoor space 131. Based on these determinations, the PD 105 an action for handoff of the PD 101 from the BS 103 to the AP 101 may be taken.

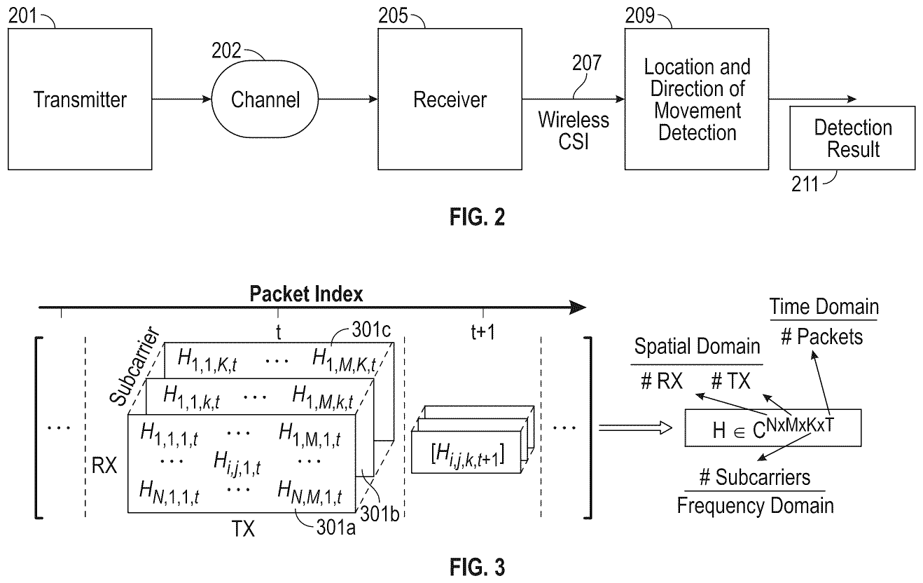

FIG. 2 illustrates an example of some embodiments in which a signal channel 203 (e.g., of signals of one or more signal frequency bandwidths, for example, radio wave, microwave, etc.) between a transmitter 201 and a receiver 205 may be analyzed to yield the CSI 207. If, based on the CSI 207 of the channel 203 the handoff system determines at 209 that the PD 105 is in or near the egress/ingress zone 115, then direction of movement of the PD 105 may be determined. Based at least in part on determining a result of the direction of movement determination 211 (e.g., determining that the PD 105 is leaving/will soon leave/has left the egress/ingress zone 115), a handoff action may be initiated or requested.

FIG. 3 illustrates an example of wireless signal channel sounding. Channel sounding may be used to build the CSI matrix 301a, 301b, 301c for the signal channel. Wireless channel sounding is a technique in which a transmitter transmits a known transmitted signal (Tx) and the received signal (Rx) is analyzed to determine signal channel characteristics. Channel sounding may be used in single-carrier and multi-carrier transmission systems like orthogonal frequency-division multiplexing (OFDM) and orthogonal frequency-division multiple access (OFDMA) in wideband and narrowband systems. A CSI matrix contains data representing the channel between the transmitter and the receiver at each of the subcarriers within OFDM. Wireless channel sounding techniques may entail a frequency domain analysis of the signal channel to obtain wireless channel characteristics. Another way to quantify the wireless channel may be to analyze the impulse response (the response from sending an impulse at the transmitter). Impulse response is a time domain method of understanding the wireless channel. The impulse response may characterize the different reflected components. CSI is discussed in more detail in Y. Ma et al., “Wi-Fi Sensing with Channel State Information: A Survey,” ACM Computing Surveys, Vol. 52, No. 3, Article 46. June 2019, the contents of which are hereby incorporated by reference herein in their entirety.

The received signals may have components at different time instants and may be delayed with respect to the transmitted signal due to the different reflections from the facial features. If there are multiple reflections before reaching the receiver, the signal would be attenuated and delayed compared to a signal path that goes through a single reflection. In addition, relative composition of reflection, refraction and diffraction would vary based on the frequency of the wireless signal. Different skin and facial features have different reflectance to wireless and electromagnetic radiation at different frequencies. Due to the different reflection characteristics, the channel sounding characteristics will be different for different locations. The channel parameter values may reflect parameters such as changes, compared with the transmission signal, of frequencies and of signal delays.

FIG. 3 shows an example of a CSI matrix of the signal channel. Some of the key items that can be derived from CSI matrix are:
1. RSSI (Received Signal strength indicator)
2. Frequency and timing shifts.
3. Doppler shift
4. Changes in fading patterns.

One of the axes for capturing wireless characteristics may be time and the other may be axis frequency. For an orthogonal frequency-division multiplexing (OFDM) system, both of these axes may be used. The CSI data may correspond to a three-dimensional matrix of values corresponding to a number of transmitting antennas (Tx), a number of receiving antennas (Rx) and a number of subcarriers, and may be indicative of amplitude and phase variation of a channel within a frequency used in the wireless transmissions. H may represent the CSI matrix; Rx-Tx may represent a receiving and transmitting antenna pair; M and N may, respectively, represent a number of transmit and receive antennas in a MIMO-OFDM channel; K may represent a number of subcarriers in the frequency domain; and T may represent a number of packets in the time domain. An example of values for these variables may be 2 for #RX and for #TX, 128 for #subcarriers, and 10 for the #packets.

The superscript may be used to denote different transmit/receive antenna combinations, as shown in the matrices of channel parameter values. In addition, the superscript can be used to denote different transmit/receive antenna combinations. Subscript 1 may indicate #packet, subscript 2 may indicate the #subcarriers, and superscript may indicate the #combination of RX and TX.

A CSI matrix may provide data for localization and direction of movement detection as it factors into consideration various elements of the wireless channel between Tx and Rx such as Doppler shift and frequency and timing shifts. The predetermined transmission pattern may be encoded in single carrier frequency, or multi-carrier technologies like OFDM, OFDMA, etc. In addition, there may be different simultaneous streams of known patterns sent by the transmitter using multiple-input and multiple-output (MIMO) technologies.

Indoor localization and tracking, including detecting direction of movement, may be done using CSI. Various additional measures may be taken using the CSI. A Kalman filter (KF) or an enhanced Kalman filter (EKF) may be used to track continuously the trajectory of a moving target. IMU sensor data may be used to reduce positioning error. In some approaches, a trajectory estimated using CSI measurements may be refined by a pedestrian dead reckoning (PDR) process via back-propagation. For example, CSI data may be refined using a Hampel filter to remove the outliers, a discrete wavelet transform to remove the noise and extract the important features, and finally, machine and deep learning algorithms to identify the walking direction for different people and in different environments.

In some embodiments, CSI measurement may be performed only when triggered by an indication that presence of the PD 105 in or near the egress/ingress zone 115 is occurring or may be imminent. This initial trigger may be an implicit parameter, such as a reduced RSSI value indicating that the PD 105 is further away from the AP 101 and/or an RSSI value trending downwards indicating that the PD 105 is moving away from the AP 101.

In some examples, the trigger may be an explicit parameter, such as a user interface indication received on the PD 105 via an application interface that the user is leaving the home or intends to do so. For example, the user interface indication may include one or more of a command to open/close a garage door, a front door or gate, a window, to close a window shade or drapes, to darken a window, to communicate presence/absence to an automated home/smart home system, to change an indoor temperature setting (e.g., to shut off the heat or the air conditioner), to shut off/turn on the light in or at the house/garage, to arm/disarm a home alarm system, to start/stop an automobile, to text someone with a message that indicates that the person is leaving/arriving home, or the like. Such indications may be entered via the PD 105 or may be entered to one or more devices and notified to the PD 105 and/or to the AP 101 or to the BS 103. Such indications may be used as a trigger to initiate CSI measurement or may be used as a preliminary trigger to detect RSSI, which upon reaching a threshold may in turn trigger CSI measurement. Or, such a user interface indication may be used to confirm that an RSSI threshold measured should trigger the CSI measurement. Other such implicit parameters and such explicit parameters for triggering CSI measurement are also contemplated. In some implementations, the CSI measurement may be performed periodically, and a trigger is not required to initiate CSI measurement.

In some implementations, the PD 105 may ask the user to confirm whether leaving the premises is intended. For example, an implicit trigger, such as RSSI, may activate a push notification to query whether the user is moving away from the home.

After the CSI measurement phase is initiated, the AP 101 may transmit a predetermined sequence to the PD 105, which may be used by the PD 105 to compute the CSI. Or, the PD 105 may transmit the predetermined sequence to the AP 101, which may be used to compute the CSI. In some implementations, some or all of the CSI processing, including determination of a location signature, may be offloaded to a device other than the device that received the predetermined signal (e.g., if the AP 101 transmits the predetermined sequence to the PD 105, the data about the received signal may be sent to the AP 101 so that it performs some or all of the CSI processing). Based on the CSI data, the location signature of the PD 105 is compared with a reference/pre-computed location signature. A direction/trajectory of movement of the PD 105 may also be computed based on the CSI, the CSI and other information, or other information alone.

Based on the signal characteristics thus identified and the known transmission signal, a pattern of channel characteristics may be determined. This pattern may be unique relative to the pattern of other channel parameter sets because the channel characteristics are unique to the physical features of the location, especially for indoor spaces. This pattern may be sufficient to generate a signal signature, which may also be thought of as a channel signature, that uniquely identifies the location of the PD 105.

In some instances, to determine a signal signature, a cluster or some pattern of data may be identified in one or more matrices of signal channel parameters. For example, a signal signature may be determined based on wireless channel characteristics (e.g., quantified by a CSI matrix) obtained from multiple distinct sets of transmitted and received signals. For each transmission (e.g., wherein one or more signals are transmitted and received as input signals), wireless channel characteristics may be determined. Determining whether a candidate location signature corresponds to a known signature may include determining a “distance” from a candidate signature to one or more clusters of known signatures in latent space. In such an example, each cluster of known signatures may correspond to various locations. An ML embedding process may be used to identify a cluster or other pattern of data that is sufficient to uniquely identify a user relative to other users. The ML-based embedding technique may be used as a classifier, which may be trained in any suitable way. For example, in some embodiments, the ML classifier may be trained, in a supervised manner, from a set of patterns in labeled channel parameter value sets to recognize distinct location patterns. In an application phase, data that is sent to the ML algorithm may also be pre-processed to remove noise, normalize inputs and the like as part of standard machine learning techniques.

The captured signal signature may be saved as a known signal signature. A candidate signal signature captured in a subsequent session may be compared against a previously saved signal signatures in an authentication phase. The processing of the received signal to determine CSI and/or the ML model clustering and signal signature identification may be implemented, in whole or in part, by one or more of the devices or systems described herein, such as the AP 101, the BS 103 and/or the PD 105. Statistical techniques may be implemented instead of machine learning algorithms, or in conjunction with machine learning algorithms, looking at the properties of the data on a per user basis, and used to distinguish between physical locations. In some embodiments, location signatures are determined for each individual portable device (e.g., a set of location signatures is associated and stored separately for the smartphone of each member of a household), for example, by identifying each portable device using its MAC address or some other parameter.

According to some embodiments, presence of the PD 105 in or near the egress/ingress zone 115 the first time (e.g., when exiting/entering a new location) may be automatically detected based on the CSI because the signal in the egress/ingress zone 115 would not be an indoor signal. In some implementations, a registration or initialization step would be required for a new location in which the PD 105 would prompt the user to indicate to the handoff system when the user is in or near the egress/ingress zone 115. The handoff system may save this signal signature of the egress/ingress zone 115. More than one such egress/ingress zone (e.g., egress/ingress zone 115 and egress/ingress zone 115b) may be saved in memory by the handoff system. The received channel sounding parameter values may be stored locally in the PD 105, the AP 101, or some other LAN network node, or may be stored remotely and then processed to generate a signal signature.

The handoff system may determine whether the channel parameter values are sufficient to generate a signal signature. If the model is unable to identify a signal pattern with a sufficiently high confidence level to generate a signal signature, then the handoff system may request a new transmission signal to try again to obtain a signal signature. A confidence threshold for identifying a signature may be set for the MIL model. A signal signature may be stored in the cloud in addition to, or instead of, locally in memory.

The CSI measurement may be computed continuously to determine whether the user first entered the egress/ingress zone 115, and then exited the egress/ingress zone 115 in the preordained (reference) direction of movement, e.g., moving away from the home. Such calculation for trajectory of movement may be further augmented with sensory input from an inertial measurement unit (EIU) for linear acceleration and angular velocity along multiple axes of motion. If all the conditions are met, then switching or steering may be used to transfer immediately the data traffic over to the cellular or other network.

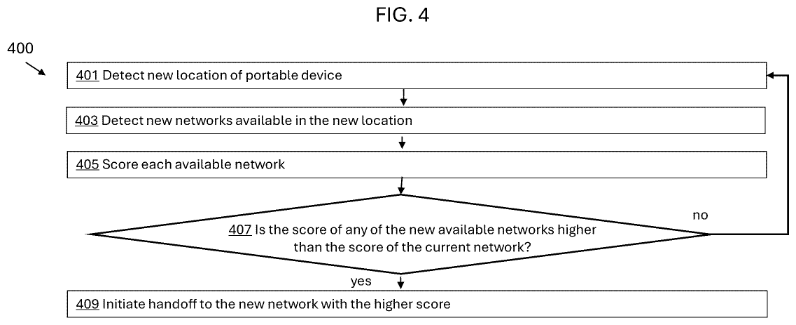

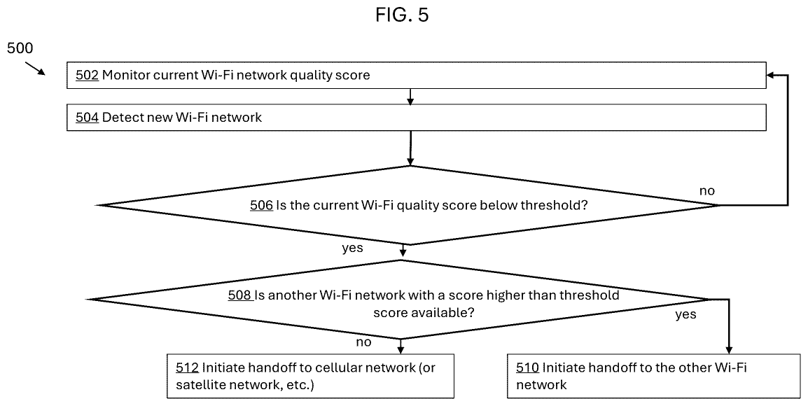

FIG. 4 illustrates steps according to some approaches that may be taken prior to determining whether to switch an PD 105 from a mobile telecommunications network to a Wi-Fi network.

At 401, the handoff system may determine whether the PD 105 has moved to a Wi-Fi coverage area. If it has not (“no” at 401), then at 403 the handoff system may determine that the PD 105 stays connected to the mobile telecommunications network. On the other hand, if the PD 105 has been determined to have moved to a Wi-Fi coverage area, then at 403 the handoff system may attempt to detect any potential alternative Wi-Fi access networks. At 405, alternative Wi-Fi access networks are scored, for example, based on RSSI values detected, signal-to-noise (S/N) ratios, or the like. At 407, it is determined whether any of the neighboring Wi-Fi APs score higher than the mobile telecom telecommunications network score. If none of them do (“no” at 407), then the handoff system may determine that the PD 105 will remain connected to the mobile telecommunications network. On the other hand, if the handoff system determines that any of the Wi-Fi networks has a higher score than the mobile telecommunications network, then at 409 the PD 105 may be switched to communication with the Wi-Fi network with the highest score. Approaches such the one illustrated in FIG. 4 may be used in conjunction with CSI-based techniques described herein. For example, in some approaches, in response to the detection of one or more trigger conditions, the handoff system may first determine whether a Wi-Fi AP different from the AP 101 that is currently communicating with the PD 105 is available with a higher score before initiating CSI measurement. Or, in some approaches if based on the CSI the PD 105 is determined to be at the egress/ingress zone, the handoff system may first determine whether a Wi-Fi AP different from the AP 101 that is currently communicating with the PD 105 is available with a higher score before initiating handoff action to the other type of telecommunications network such as the cellular network.

FIG. 5 illustrates steps according to some approaches that may be taken prior to determining to switch the PD 105 from a Wi-Fi network to a mobile telecommunications network.

At 502, the handoff system may monitor the Wi-Fi network for network signal quality based on one or more parameters. At 504, the PD 105 may discover one or more other Wi-Fi access networks available to the PD 105. At 506, the handoff system may calculate a score for the current network serving the PD 105. The handoff system may score signal quality according to predetermined network operator preferences based on one or more criteria, such as RSSI, S/N or the like. If the Wi-Fi network currently providing communication for the PD 105 meets or exceeds the score threshold then the PD 105 may remain connected to the currently serving Wi-Fi at 506 and processing may return to 502. Network monitoring at 502 may resume.

If the current Wi-Fi network does not meet or exceed a minimum threshold score, then at 508, the handoff system may determine the score other available Wi-Fi networks. This determination may be performed earlier in the process, for example, before deciding the current Wi-Fi network's score. At 508, it is determined whether an alternate Wi-Fi network that has been discovered has a higher network score that exceeds the threshold. If none do, then at 512 a switch to a mobile telecommunication network is requested. However, if an alternate Wi-Fi network is discovered with a satisfactory score that meets the threshold, then at 510 the new Wi-Fi access network is selected and the PD 105 may be transitioned from the existing Wi-Fi network to the new Wi-Fi network. As discussed, with respect to the process shown in FIG. 4, in some embodiments, the process shown in FIG. 5 may be used in conjunction with the CSI-based process described herein. In some embodiments, the processes shown in FIGS. 4 and 5 would be avoided.

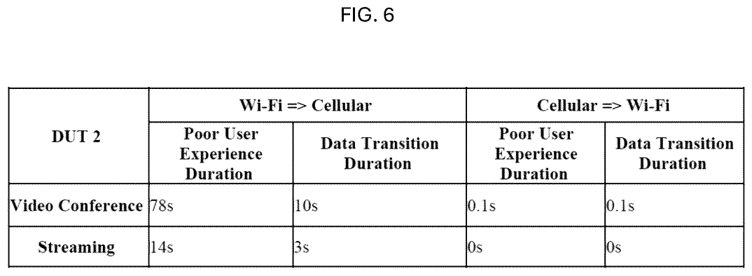

FIG. 6 is a table illustrating the time taken to transition from Wi-Fi network to a mobile telecommunication network, according to approaches that use a “Wi-Fi first” principle described above. As discussed, such approaches may sometimes result in a situation in which it takes longer to switch from a Wi-Fi network to a mobile communications network than to switch from a mobile telecommunication network to a Wi-Fi network.

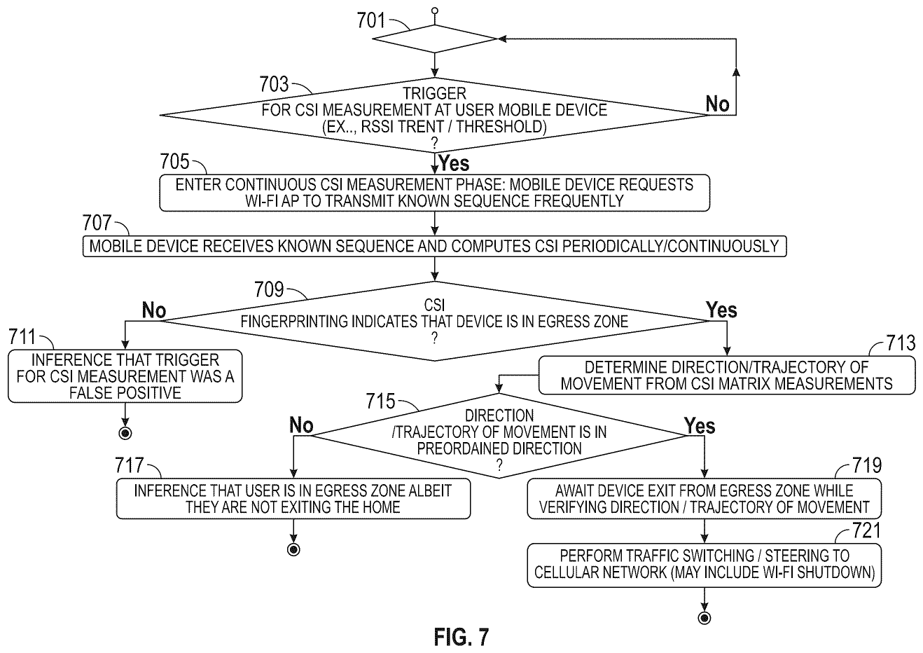

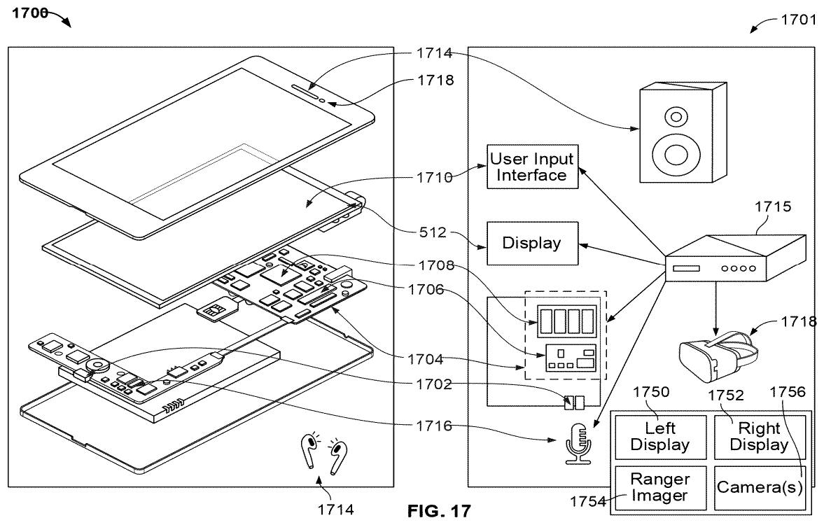

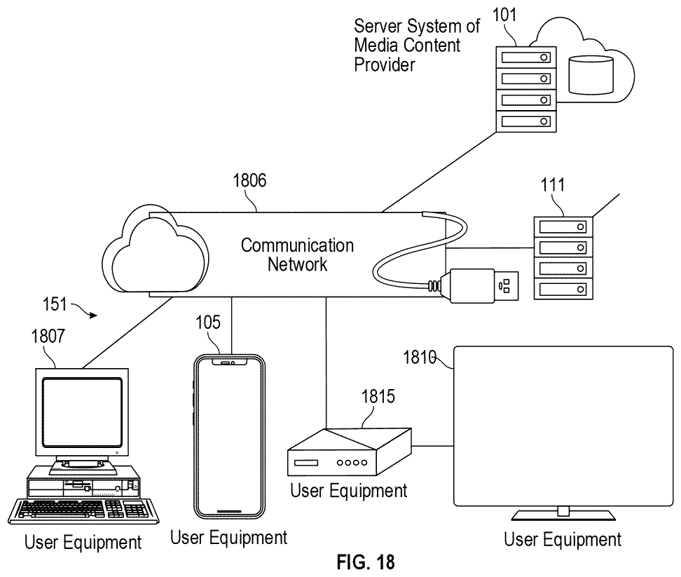

FIG. 7 is a flowchart illustrating an example of a process 700 for determining to switch from a Wi-Fi network to a mobile telecommunications network, according to an aspect of some embodiments of the present disclosure. One or more actions of the method 700 may be incorporated into or combined with one or more actions of any other process or embodiments described herein. These and other methods described herein, or portions thereof, may be saved to a memory or storage (e.g., of the handoff systems shown in FIG. 17 or 18) or locally as one or more instructions or routines, which may be executed by any suitable device or system having access to the memory or storage to implement these methods.

As shown in FIG. 7, an egress/ingress zone 115 may be identified by determining ingress/egress points. At 701, the handoff system may start monitoring for one or more triggers for initiating CSI measurement. As discussed with regard to FIG. 1, such a trigger may be one or more various implicit or explicit parameters. Such implicit or explicit parameters may be transmitted to the PD 105 and or to the AP 101.

At 703, the handoff system may determine that one or more of the implicit or explicit parameters has reached a predetermined threshold. For example, the handoff system may determine that the RSSI value is below a critical threshold. If the trigger threshold has not been reached, then the handoff system may return to 701 where the handoff system monitors for triggers. Such a determination may be made by the PD 105 and/or by the AP 101.

On the other hand, if the trigger threshold is met (“yes”), then at 705 the handoff system may commence CSI measurement. The AP 101 may transmit a predetermined signal sequence, (e.g., pursuant to request of the PD 105). Also, as discussed with regard to FIG. 1, the predetermined signal sequence may be transmitted by PD 105 to AP 101.

At 707, the PD 105 (or the AP 101) may receive the predetermined signal sequence. The CSI measurements may be performed by the PD 105 and/or by the AP 101.

At 709, based on the CSI, the handoff system may determine whether the PD 105 is in or near an egress/ingress zone 115. In some embodiments, the egress/ingress zone 115 may be determined by its location signature identified based on the CSI data. The handoff system may identify that the user is in the egress/ingress zone 115 using the location signature derived from the CSI matrix.

If, at 709, the handoff system determines that the PD 105 is not in the egress/ingress zone 115, then the handoff system at 711 may determines that the trigger for commencing CSI measurement was a false positive and the handoff system may return to 701 for further monitoring.

If, at 709, the handoff system determines that the PD 105 is in the egress/ingress zone 115, then the handoff system at 713 may identify a direction of movement. For example, the direction of movement of the PD 105 may be determined based on the CSI matrix and/or IMU-based sensing for angular velocity and linear acceleration along multiple axes of motion. GPS data may be used to determine a time series of recent locations to determine the direction of motion. In some embodiments, the handoff system may determine whether the PD 105 is moving in a direction away from the AP 101 and/or away from a previous position in an indoor space. Also, such a direction of movement may be determined by comparing the direction of movement now detected to one or more PD 105 trajectories on previous occasions just before the PD 105 was switched between the Wi-Fi network and the mobile telecommunications network. If no such direction of movement is detected, then at 717, the handoff system may determine that the PD 105 is not really leaving and the handoff system may return to monitoring at 701.

Subsequently, at 715, the handoff system may verify that the user is moving or has moved out of the egress/ingress zone 115 with the current movement direction. If so, then at 719, the handoff system may await confirmation that the PD 105 has moved out of the egress/ingress zone 115 and, if it has, the handoff system may take action to switch or to steer the PD 105 to the mobile telecommunications network using BS 103. However, in some implementations, the handoff system may not await confirmation that the PD 105 has moved out of the egress/ingress zone 115 before taking the action to switch or to steer the PD 105 to the mobile telecommunications network.

At 721, the handoff system may infer that the PD 105 is leaving the premises (home or office or other Wi-Fi signal coverage area). In response, the handoff system may terminate connection to the Wi-Fi to force the traffic to switch or otherwise steer the PD 105 to the cellular connection.

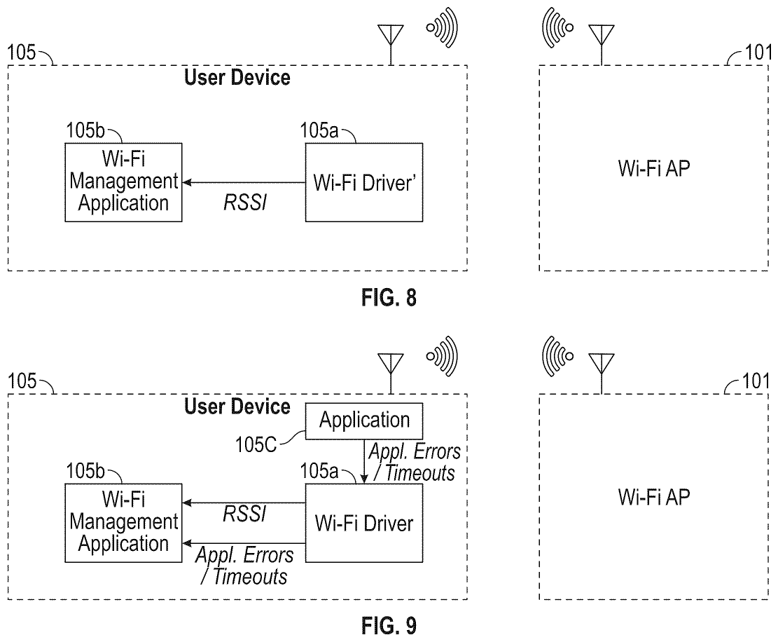

FIG. 8 illustrates an example of triggering process for CSI measurement according to an implementation of the disclosure. One or more of the triggering processes described herein may be used during regular operation to initiate CSI measurement. One or more of the triggering processes described herein may be used during a calibration mode to measure and store a reference CSI for the portable device 105. When RSSI derived from a Wi-Fi driver 105a of PD 105 is detected to below a threshold level, and/or is detected to have an RSSI trend that is decreasing at a predetermined threshold rate, then a Wi-Fi management application 105b of the PD 105 may query the user with a push notification as to whether the user intends to move out of the home and/or as to whether the user wants to transfer traffic to the cellular connection.

FIG. 9 illustrates another example of triggering process for CSI measurement according to an implementation of the disclosure. As indicated in FIG. 9, an application 105c of PD 105 may signal to the Wi-Fi driver 105a when a loss in QoS is detected. This application 105c may be an active audio streaming, video streaming, videoconferencing application or some other application that involves real time data sharing downstream to the PD 105 or upstream from the PD 105. For example, the loss in QoS may manifest as errors and/or timeouts in requests (for example, HTTP requests). Such timeouts/errors may be conveyed to the Wi-Fi management application 105c which, in response, signal the Wi-Fi driver 105a to trigger CSI measurement.

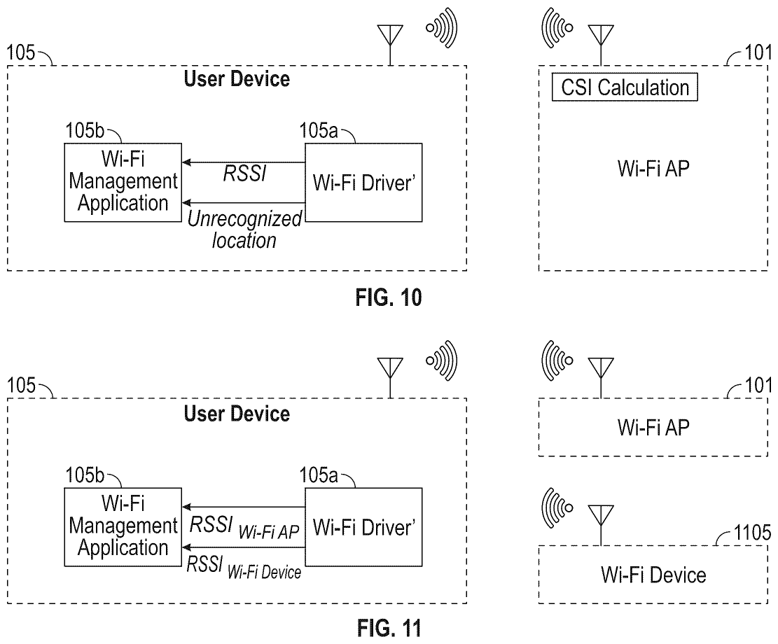

FIG. 10 illustrates another example of a triggering process for CSI measurement according to an implementation of the disclosure. As indicated in FIG. 10, the AP 101 may map the premises and its environs, collecting footprints for a plethora of locations. This allows the AP 101 to perform localization within the premises. To collect these footprints, the AP 101 may transmit a known signal sequence to the PD 105, which may store raw CSI data derived from the known signal sequence transmission and transmit this raw CSI data back to the AP 101. The AP 101 may then use an embedding to create a signal signature of the location. Using such an approach, CSI measurement may be triggered when:
A. The PD 105 is determined to be localized to the front/foyer/entryway of the home (e.g., a egress/ingress zone adjacent location near the egress/ingress zone 115 but still indoors), or
B. The PD 105 enters an unrecognized location (no corresponding reference location signature) immediately after condition A.

RSSI data may also be used to confirm that the PD 105 is in the adjacent location, for example, based on detection of the PD 105 trajectory moving away from the AP 101.

FIG. 11 illustrates another example of a triggering process for CSI measurement according to an implementation of the disclosure. As indicated in FIG. 11, the CSI trigger may be derived from proximity to a second device 1105 with a known location (e.g., fixed to a location or a Wi-Fi-enabled device whose location has been otherwise confirmed) at the periphery of the home, such as a camera video doorbell, automated home management device, or a security camera. Proximity of the PD 105 to the second device 1105 may be measured using RSSI. If the second device cannot operate in AP mode, then a peer-to-peer Wi-Fi communication mode such as Wi-Fi Aware may be used between the PD 105 and the second device 1105. A combined logic of proximity to the second device 1105 and increasing distance to the Wi-Fi AP may be used as a single trigger for initiating CSI measurement.

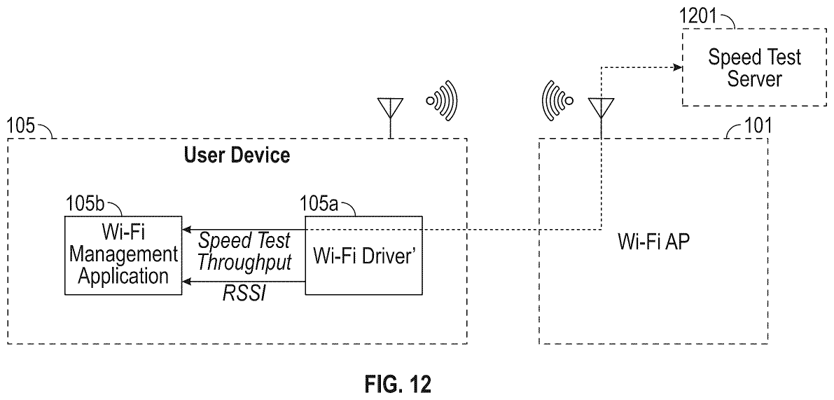

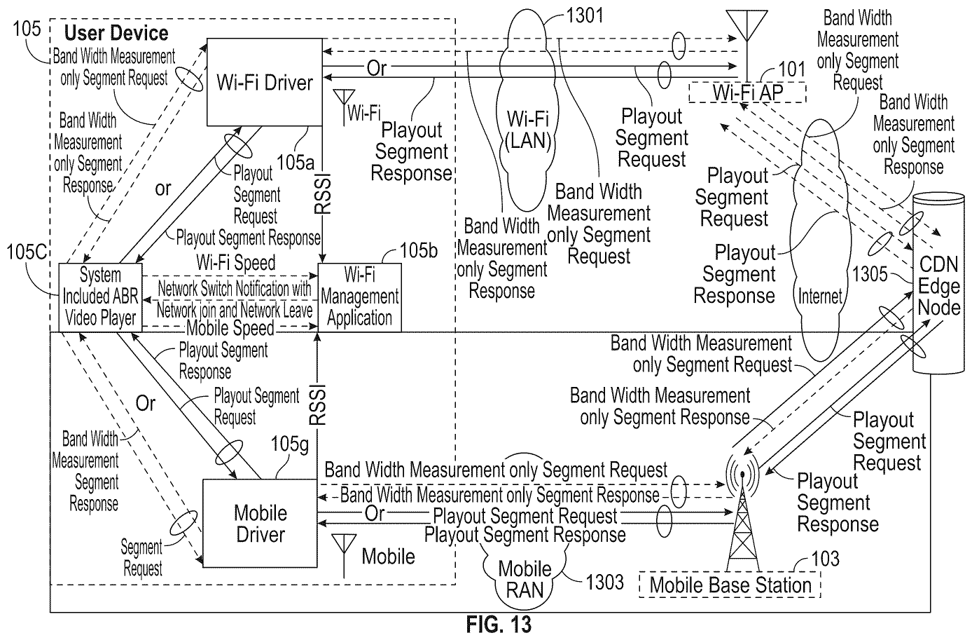

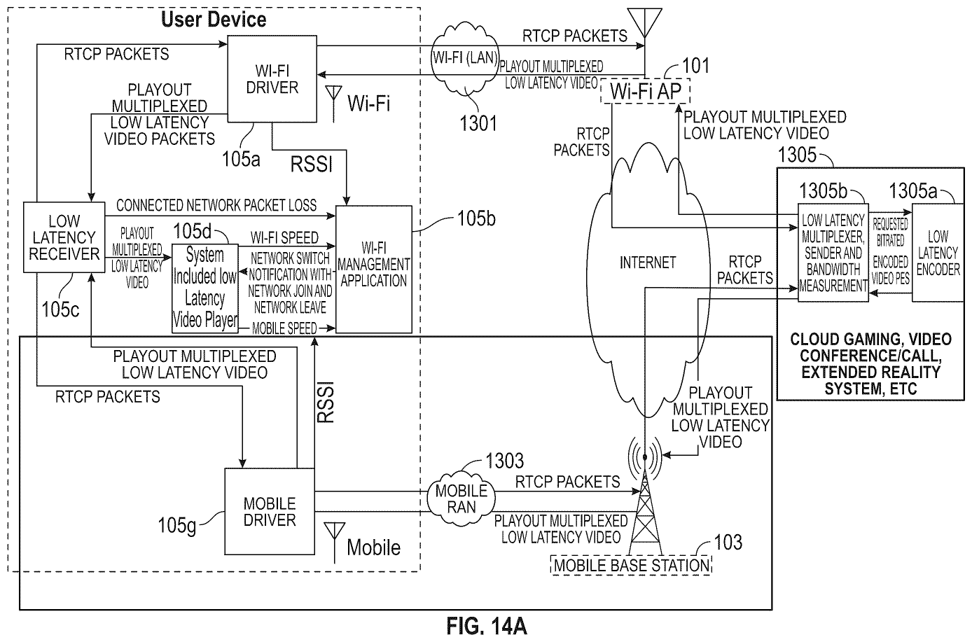

FIG. 12 illustrates another example of a triggering process for CSI measurement according to an implementation of the disclosure. As indicated in FIG. 12, in addition to, or instead of, verifying that the Wi-Fi signal has a low RSSI, the PD 105 may also initiate a short speed test to validate that the throughput is either low or rapidly reducing due to low signal strength. A speed test client may be integrated into the Wi-Fi management application 105b from the service provider, however, a version of a typical speed test (for example, measurement for 1 second) in communication with a speed test server 1201 may be used to trigger CSI measurement. Speed testing may be used to augment the process illustrated in FIGS. 8-11. Any two of the triggering processes may be used in combination to determine the CSI measurement trigger.

A speed test may measure the throughput of the network's bandwidth in one or more different ways. During normal usage of the network, for example, video streaming, minimal impact on current use may be made using passive speed monitoring, particularly if network bandwidth is unavailable for an active speed test. Using passive speed monitoring, without injecting additional data into the network traffic, network traffic already flowing through the network may be analyzed to determine metrics such as throughput, latency, and packet loss. This may be done using network monitoring tools and/or using built-in router features that track usage in real time. If live streaming is already lagging, that lag may be measured as an indicator of the current throughput of the network. In some embodiments, if network bandwidth is not fully occupied, lightweight active probing may be used to measure network speed. In some embodiments, instead of saturating the connection with a large data chunk, the system may transmit small, infrequent probe packets, which can be used to measure the delivery time to yield a snapshot of network performance while having a negligible impact on the live streaming. Other types of network speed are also contemplated.

Another option is to leverage functionality that applications are using, such as video players, as the trigger for CSI measurement initiation. Windows, Apple MacOS, Android and iOS operating systems may include adaptive bit rate (ABR) video players. ABR video content may be produced for OTT delivery for the application services and websites. To play out the ABR video, applications and web browsers may use the included ABR players and codecs included with the OS distribution. The handoff system may gather network bandwidth and QoS statistics while the video or other content is streaming.

FIG. 13 illustrates another example of a triggering process for CSI measurement according to an implementation of the disclosure. As indicated in FIG. 13, if the currently connected network is the Wi-Fi network 1301, an ABR player 105c of the PD 105 may be playing live or VOD video by downloading the segments that are represented in the ABR manifest. The ABR manifest may include bitrate ladder ranges for the video encoding. If the handoff system decides, based on the ABR ladder in the manifest, that the ABR player 105c is not downloading the highest quality video data, or is not downloading the ladder range set at a threshold, or determines that a notable decrease in bandwidth is experienced, the ABR player 105c may report (e.g., to the Wi-Fi measurement application 105b) the measured download bandwidth or bitrate, or a decrease in bandwidth or bitrate.

The ABR video player 105c may download segments over the mobile network from the same manifest to perform a mobile network bandwidth measurement. The mobile bandwidth measurement may be sent to the Wi-Fi management system 105b. The Wi-Fi management system 105b may receive the RSSI from both the Wi-Fi driver 105a and the mobile driver 105g. Based on the RSSI and/or based on the bandwidth reporting from the Wi-Fi network 1301 and/or the mobile network 1303, the Wi-Fi management application 105a may select a network for continued network sessions and may initiate the switchover.

If the ABR video is being played over the mobile network 1303 and begins to experience a drop in bandwidth, bandwidth measurements may be performed over the Wi-Fi network and depending on RSSI and bandwidth from the mobile and Wi-Fi network 1301, the Wi-Fi management application 105b may switch network session from the mobile network 1303 to the Wi-Fi network 1301.

Low latency video streaming for video calling and video conferencing and extreme low latency interactive applications like cloud gaming may use a different streaming technology and architecture for receiving video. Device operating systems such as Android and iOS may include demultiplexers and video decoders that are capable of decoding the video in these video streaming cases. Desktop and laptop operating systems such as Microsoft, MacOS and Linux may also include their own video demultiplexers and decoders. The applications may include their own libraries and functionality for the actual streaming leveraging technologies built on top of real-time transport protocol (RTP), such as WebRTC or self-clocked rate adaptation for multimedia (SCReAM). In most cases, these third party or opensource streaming libraries may use the included multiplexers and codecs. These systems are true streaming protocols using a push model, not an over the top (OTT) ABR video pull model. There is no manifest that includes ABR bitrate ladders according to which the player determines the bitrate based on the manifest advertised bitrate for the segments, the segment lengths and the amount of time to download a segment. In the low to extreme low latency case, the handoff system streams over a low latency streaming protocol like RTP (Real Time Protocol using UDP) from the server to the client device.

For every RTP packet transmitted from the low latency cloud based streaming service and received by the PD 105, the PD 105 may respond with a Real Time Control Protocol (RTCP) packet. Using this system, the server may measure the bandwidth based on the rate of the packets being delivered to the client device.

According to such an RTCP-based approach, for example, a packet queue may be used and, based on whether the packet was successfully sent to the client and an RTCP packet was received for the RTP packet, the successful RTP packet may be removed from the queue. If there are packet drops, the RTCP packet may include a packet retransmit request for packet recovery. Based on the size of the queue, the sender may either keep the encoded bitrate the same, increase or decrease the encoded bitrate. The incoming video stream (e.g., an MPEG encoded video stream) may include the encoded bitrate in the packet header's metadata. This, along with the number of RTCP packet drops may be leveraged to gain insights into the bandwidth and network QoS.

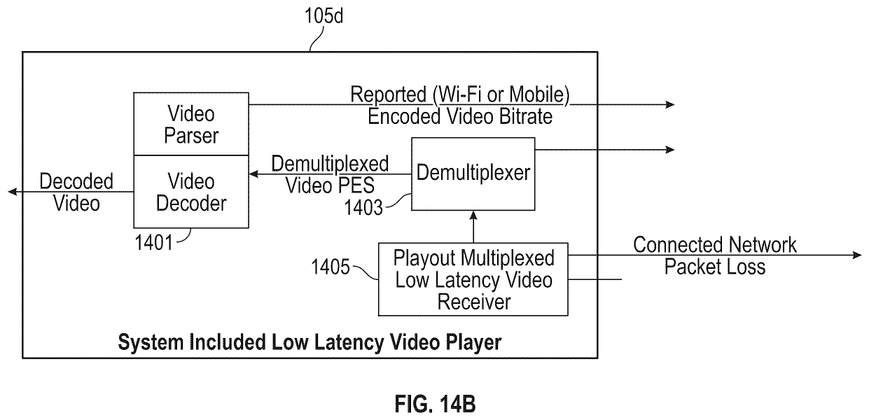

FIG. 14 illustrates an example architecture of a low latency transport system and video player using the network bandwidth and network QoS insights. The ABR video player with OTT progressive download video or the extreme low latency system may perform testing over both networks for a reliability test for each network, or may perform testing over just one network for a reliability of the network.

The network edge 1305 may perform processing to maintain a useable stream, and thus, according to an implementation, a quality metric may be used only for the current connected network. For each video RTP packet received, the Low Latency Receiver 105c of the PD 105 may respond with an RTCP packet to the Low Latency Sender 1305b of network edge 1305. Each RTP packet may include a sequence number that may be incremented by one for each packet sent. If the sequence number jumps, this indicates packet less and the Low Latency Receiver 105c may request a packet retransmit with the packet sequence number to the RTP Sender 1305. When packet loss occurs, this metric may be sent from the Low Latency Receiver 205c to the Wi-Fi Management Application 105d for a network quality metric regarding packet loss. If there is no packet loss, an RTCP packet may be sent to the RTP sender 1305d including the corresponding RTP packet. In response to this, the RTP sender 1305c may remove the RTP packet from the RTP queue. If the RTP queue is shrinking, the RTP sender 1305c may request an increase in the video encoding bitrate. If the RTP queue is growing, the RTP sender 1305c may request a decrease in the video encoding bitrate. In the RTP queue is within a desired size and not shrinking or growing, the encoding bitrate may not be changed.

In one implementation, the video encoder 1305a may write its encoded bitrate into the metadata included in the encoded video packet headers. Some video codecs may include the bitrate information in the Sequence Parameter Set (SPS). In some implementations, the multiplexed (container) headers, such as MP4, MKV, AVI, or TS, may include the multiplexed bitrate. As the video packets are received on the user device's low latency receiver 105c, they may be sent to the handoff system including low latency video player 105d where they may be demultiplex by demultiplexer 1403 or the video player 105d may only decode the video provided a third party multiplexer is included. The handoff system supplied Video Decoder 1401 may parse the PES packet headers for the encoded video bitrate and report the encoded video bitrate to the Wi-Fi Management Application 105b so that the network's bandwidth characteristics may be known. Based on one or more factors such as RSSI, CSI matrix and network quality and bandwidth, the Wi-Fi management system may choose to switch to the mobile network from the Wi-Fi network for all application network sessions.

If the current connection of the PD 105 is over the mobile network 1303, the same techniques may be applied and a switch may be made to the Wi-Fi network 1301. Techniques describe herein to trigger CSI measurement to determine a reference egress/ingress zone 115 may be used also to trigger CSI measurement for subsequent PD 105 localization after the reference egress/ingress zone 115 has been obtained and stored. Whether the current network of communication for the PD 105 is the mobile network 1303 or the Wi-Fi network 1301, CSI measurements may be made on the mobile network 1303, the CSI measurements may be made on the Wi-Fi network 1301, or the CSI measurements may be made on both the mobile network 1303 and the Wi-Fi network 1301.

An alternate to the speed test server is an application programming interface (API), which may allow an application or a lower level library, such as a video streaming/decoding library, to be used for reporting bandwidth to the handoff system. This may be done through an API call to the Wi-Fi Management Application 105b above. Access traffic steering, switching & splitting (ATSSS)—part of the 3rd Generation Partnership Project (3GPP)—may be used as an enabler/trigger for CSI measurement.

ATSSS addresses how traffic may be steered, switched or split across Wi-Fi and 5G networks. ATSSS describes use of multipath transmission control protocol (MPTCP) to allow IP data traffic to flow simultaneously over Wi-Fi and 5G networks. Since few applications and web servers support MPTCP, the ATSSS specifies an MTCP Proxy implemented in the 5G core User Plane Function (UPF). It also defines an ATSSS low layer functionality (ATSSS-LL) to support protocols such as user datagram protocol (UDP). The performance measurement function may also be used to evaluate either network's performance for decision-making. For example, in the ATSSS “Smallest Delay” steering mode, traffic may be sent over the access network with the smallest delay. The Performance Measurement Function (PMF) determines the latency of each network connection. As described herein, one or more triggers, such as RSSI, throughput (direct via speed test or indirect via application/OS), application errors/timeouts etc. may be used to trigger a CSI measurement. Subsequently, traffic switching/steering/splitting may be performed if the egress/ingress zone 115 and movement trajectory test positive. Thus, the determination that the PD 105 is leaving the premises is made between the indicatory tests and subsequent actions for network handoff. The indicatory signals derived from an ATSSS Performance Measurement function may be used to trigger CSI measurement for calibration or regular mode operation. Subsequently ATSSS functions of steering/switching/splitting may be performed.

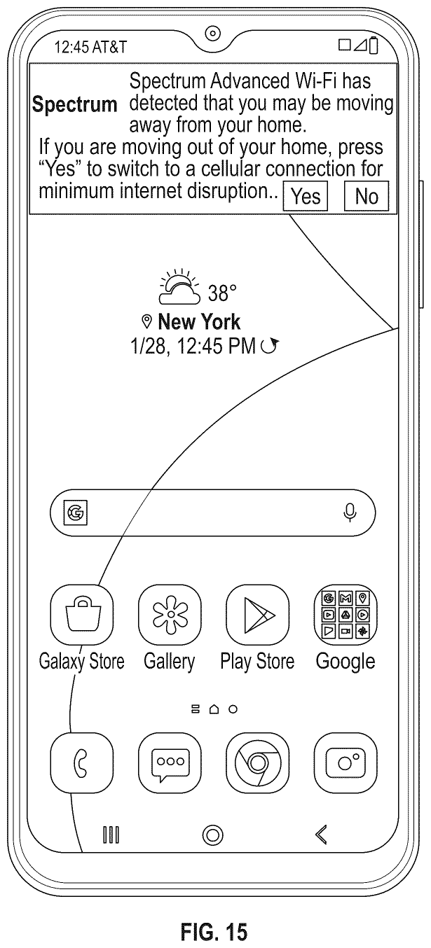

FIG. 15 illustrates an example of a type of push notification that may be delivered to a user device, for example to the PD 105, to validate that the user is indeed moving off the premises where the Wi-Fi AP 101 is located. After reference CSI measurements are collected, the handoff system may automatically transmit a query to the user device asking whether the user intends to move the user device off premises. The query may identify the location of the PD 105, for example, in relation to the indoor spaces according to the CSI measurement. The query may identify the location of the egress/ingress zone 115, for example, based on a history of CSI data. The identification may be displayed as a map showing the location of one or more egress/ingress 115 zone and the PD 105. In some embodiments, the query may be sent prior to initiating CSI measurement to request confirmation that the CSI measurement is to be initiated. In some embodiments, the query may be sent after the CSI measurement indicates that the PD 105 is in the one or more egress/ingress 115 zone to request confirmation that the PD 105 is to be leaving the premises. In some embodiments, the query may be sent after the CSI measurement indicates that the PD 105 is in the one or more egress/ingress 115 zone and the handoff system determines that the PD 105 appears to be leaving the premises to request confirmation that the PD 105 is to be leaving the premises.

Based on a user interface input in response to the query, the handoff system may cause a switch the PD 105 to the cellular network via traffic switching/steering or by initiating or requesting handoff to the other network in other ways.

In some embodiments, smart home devices such as cameras, audio/video doorbells, voice assistants, door locks, sensors etc. may assist with triggering the CSI measurement, determining or confirming location of the PD 105 in, at or near the one or more egress/ingress 115 zone, and/or determining a direction of movement of the PD 105 in, at or near the one or more egress/ingress 115 zone. A stationary smart home device at the edge/periphery of the premises, or at or near the one or more egress/ingress 115 zone, may be used to improve the localization of the user device by verifying proximity using RSSI. This may be used to trigger Calibration and CSI measurement. In some embodiments, a smart home device may be directed by the Wi-Fi AP 101 to transmit the known sequence to the user device for continuous CSI measurement. The Wi-Fi AP 101 may, for example, infer that its signal strength to the PD 105 is weak at the periphery of the premises, which may lead to a weaker (less accurate) reference CSI measurement for the one or more egress/ingress 115 zone localization and determination of PD 105 trajectory, as well as less accurate subsequent measurements for comparison to the reference values. Thus, the handoff system may designate a smart home device to assist with CSI measurement by transmitting the known sequence to the PD 105. In some implementations, the collected CSI may be transmitted to another device on premises (e.g., to the Wi-Fi AP 101) or in the cloud (e.g., a cloud Wi-Fi orchestrator) for the localization/computation and/or for the determination of PD 105 trajectory.

The handoff system may also initiate or request handoff to the Wi-Fi AP 101 from a second network, such as from the cellular network back (e.g., when the PD 105 is coming to the premises). In such a case, the one or more egress/ingress 115 zone is an ingress zone (as opposed to an egress zone when the PD 105 is leaving the premises). CSI measurement may be triggered based on RSSI or other data, as detected by the Wi-Fi AP 101 and/or by BS 103 of the mobile telecommunications network or the like. The direction of movement vector may be reversed to account for the movement of the PD 105 toward the indoor space.

In some embodiments, when the handoff system determines that the PD 105 is to be switched to communication with the second network, the PD 105, the Wi-Fi AP 101, and/or the BS 103 may inform other devices to also switch/steer traffic to the second network. For example, if the PD 105 is a cellular smartphone, it may inform a second user device, such as a smartwatch or XR (AR/VR/MR) glasses or other gear, to also perform the traffic steering/switching away from Wi-Fi AP 101 to the BS 103. For example, the PD 105 may perform an RF (radio frequency-based) proximity test or conduction-based proximity test to detect that the second device currently lies in the Wi-Fi LAN and/or is physically close to the PD 105. In some cases, an RF proximity test (e.g., using Bluetooth Low Energy—BLE) may be further augmented by the PD 105 querying the secondary device's movement. Such movement may be derived from an inertial measurement unit (IMU) that gives the second device's angular velocity and linear acceleration along three axes of motion. By verifying that the second device's angular velocity and linear acceleration match the angular velocity and linear acceleration of the PD 105 along a plurality of (not necessarily all three) axes of motion, the primary device may infer that the second device is currently moving with the user (e.g., the second device is moving together with the PD 105). After such verification, the PD 105 may send a message to the second device to perform traffic steering/switching to the BS 103. The second device may thus be handed off without the need for it to perform CSI measurement and embedding (computation-intensive processing). A user confirmation as discussed with respect to FIG. 15, may, in some embodiments, be used as part of a calibration mode to establish a reference CSI for the portable device 105 for the egress/ingress zone. Such a user confirmation may be used, in some embodiments, in normal use after calibration.

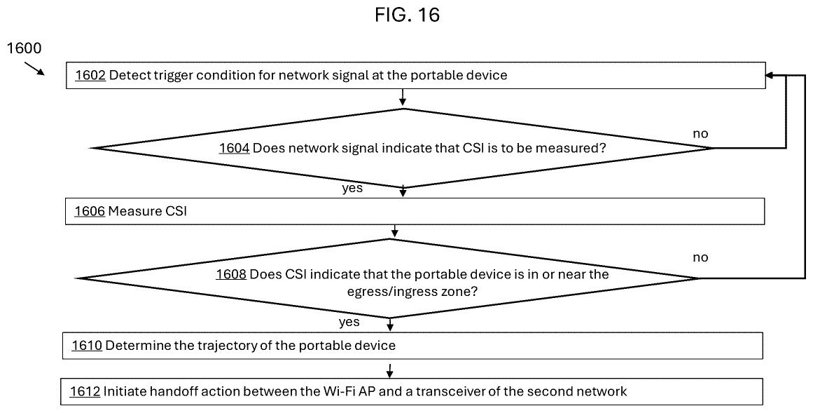

FIG. 16 is a flowchart illustrating an example of a process 1600 for determining to switch the PD 105 from a Wi-Fi AP to a second telecommunications network, according to an aspect of some embodiments of the present disclosure. One or more actions of the method 1600 may be incorporated into or combined with one or more actions of any other process or embodiments described herein. These and other methods described herein, or portions thereof, may be saved to a memory or storage (e.g., of the handoff systems shown in FIG. 17 or 18) or locally as one or more instructions or routines, which may be executed by any suitable device or system having access to the memory or storage to implement these methods.

At 1602, the handoff system may receive data that may be used to trigger for activating CSI measurement. For example, the user wearing or holding a smartphone may be entering one or more of the egress/ingress zones 115, which may be detected based on signal strength at or near a periphery of the signal range of the AP 101 or based on signal strength outside of a building versus inside of a building in which the AP 101 is located. One or more of the egress/ingress zones 115 may be indoors or outdoors. One or more of the egress/ingress zones 115 may be at a periphery of the signal range of the AP 101 or may be well within the signal range of the AP 101.

At 1604, the handoff system may decide whether the trigger condition has been detected. Two or more metrics may be used to determine a trigger condition. If the trigger is determined to not have met a threshold condition, then processing returns to 1602.

At 1606, the handoff system may start measuring CSI. The CSI may include a CSI measurement of the network signal channel between the AP 101 and the PD 105 and/or a CSI measurement of the network signal channel between the PD 105 and the BS 103 or a transceiver of the second telecommunications network. The CSI may be measured by the AP 101, by the PD 105, and/or by the BS 103 or the transceiver of the second telecommunications network.

At 1608, the handoff system may determine whether, based on the CSI measurement(s), the PD 105 is at or near one or more of the egress/ingress zones 115. The input signal readings received based on which the CSI is calculated may be performed by a different device from the device that received the input signal. The input signal readings may be transmitted to, and processed by the AP 101, by the PD 105, and/or by the BS 103 or the transceiver of the second telecommunications network.

At 1610, the handoff system may determine a trajectory of the PD 105. One or more techniques may be used to determine the trajectory of the PD 105.

At 1612, the handoff system may initiate handoff of network traffic communication of the PD 101 between the AP 101 and the BS 103 or the transceiver of the second telecommunications network. The handoff system may also transmit a notification to the PD 105 or to another device associated with a user profile that the handoff has been initiated or that the handoff has been completed.

FIGS. 17-18 describe illustrative devices, systems, servers, and related hardware for determining to initiate CSI measurement, CSI measurement, trajectory determination and related tasks according to aspects of embodiments of this disclosure. FIG. 17 shows generalized embodiments of illustrative user equipment devices 1700 and 1701, which may correspond to, e.g., computing devices 101, 103. For example, user equipment device 1700 may be a smartphone device, a tablet, a virtual reality or augmented reality device, or any other suitable device capable of processing video data. In another example, user equipment device 1701 may be a user television equipment system or device. User television equipment device 1701 may include set-top bot 1715. In some embodiments, display 1712 may be a television display or a computer display. In some embodiments, set-top bot 1715 may be communicatively connected to user input interface 1710. In some embodiments, user input interface 1710 may be a remote-control device. Set-top bot 1715 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path.

Each one of user equipment device 1700 and user equipment device 1701 may receive content and data via input/output (I/O) path 1702 that may comprise I/O circuitry (e.g., network card, or wireless transceiver). I/O path 1702 may provide content (e.g., broadcast programming, on-demand programming, Internet content, content available over a local area network (LAN) or wide area network (WAN), and/or other content) and data to control circuitry 1704, which may comprise processing circuitry 1706 and storage 1708. Control circuitry 1704 may be used to send and receive commands, requests, and other suitable data using I/O path 502, which may comprise I/O circuitry. I/O path 1702 may connect control circuitry 1704 (and specifically processing circuitry 1706) to one or more communications paths (described below). I/O functions may be provided by one or more of these communications paths, but are shown as a single path in FIG. 17 to avoid overcomplicating the drawing. While set-top bot 515 is shown in FIG. 18 for illustration, any suitable computing device having processing circuitry, control circuitry, and storage may be used in accordance with the present disclosure.

Control circuitry 1704 may be based on any suitable control circuitry such as processing circuitry 1706. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 1704 executes instructions for the handoff system stored in memory (e.g., storage 1708). Specifically, control circuitry 1704 may be instructed to perform the functions discussed above and below. In some implementations, processing or actions performed by control circuitry 1704 may be based on instructions received from the handoff system.

In client/server-based embodiments, control circuitry 1704 may include communications circuitry suitable for communicating with a server or other networks or servers. The handoff system may be a stand-alone application implemented on a device or a server. The handoff system may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 17, the instructions may be stored in storage 1708, and executed by control circuitry 1704 of a device 1700.

In some embodiments, one or more of the applications may be a client/server application where only the client application resides on device 1700 (e.g., device 104), and a server application resides on an external server (e.g., server 804 and/or server 816). For example, the application may be implemented partially as a client application on control circuitry 1704 of device 1700 and partially on server 804 as a server application running on control circuitry 811. Server 804 may be a part of a local area network with one or more of devices 1700 or may be part of a cloud computing environment accessed via the internet. In a cloud computing environment, various types of computing services for performing searches on the internet or informational databases, providing storage (e.g., for a database) or parsing data (e.g., using machine learning algorithms described above and below) are provided by a collection of network-accessible computing and storage resources (e.g., server 804 and/or edge computing device 816), referred to as “the cloud.” Device 800 may be a cloud client that relies on the cloud computing capabilities from server 804 to determine whether processing (e.g., at least a portion of virtual background processing and/or at least a portion of other processing tasks) should be offloaded from the mobile device, and facilitate such offloading. When executed by control circuitry of server 804 or 816, the handoff system may instruct control 811 or 818 circuitry to perform processing tasks for the client device and facilitate the tasks herein described or provided therefor.

Control circuitry 1704 may include communications circuitry suitable for communicating with a server, edge computing systems and devices, a table or database server, or other networks or servers The instructions for carrying out the above mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 18). In addition, communications circuitry may include circuitry that enables peer-to-peer communication of user equipment devices, or communication of user equipment devices in locations remote from each other (described in more detail below).

Memory may be an electronic storage device provided as storage 1708 that is part of control circuitry 1704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1708 may be used to store various types of content described herein as well as handoff system data described above (e.g., database 420). Nonvolatile memory may also be used (e.g., to launch a boot-up routine and other instructions). Cloud-based storage, described in relation to FIG. 17, may be used to supplement storage 1708 or instead of storage 1708.

Control circuitry 1704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1704 may also include scaler circuitry for upconverting and downconverting content into the preferred output format of user equipment 1700. Control circuitry 1704 may also include digital-to-analog converter circuitry and analog-to-digital converter circuitry for converting between digital and analog signals. The tuning and encoding circuitry may be used by user equipment device 1700, 1701 to receive and to display, to play, or to record content. The tuning and encoding circuitry may also be used to receive video AR generation data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to process simultaneous tuning functions (e.g., watch and record functions, picture-in-picture (PIP) functions, multiple-tuner recording, etc.). If storage 1708 is provided as a separate device from user equipment device 1700, the tuning and encoding circuitry (including multiple tuners) may be associated with storage 1708.

Control circuitry 1704 may receive instruction from a user by way of user input interface 1710. User input interface 1710 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of each one of user equipment device 1700 and user equipment device 1701. For example, display 512 may be a touchscreen or touch-sensitive display. In such circumstances, user input interface 1710 may be integrated with or combined with display 1712. In some embodiments, user input interface 1710 includes a remote-control device having one or more microphones, buttons, keypads, any other components configured to receive user input or combinations thereof. For example, user input interface 1710 may include a handheld remote-control device having an alphanumeric keypad and option buttons. In a further example, user input interface 1710 may include a handheld remote-control device having a microphone and control circuitry configured to receive and identify voice commands and transmit information to set-top bot 1715.

Audio output equipment 1714 may be integrated with or combined with display 1712. Display 1712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1712. Audio output equipment 1714 may be provided as integrated with other elements of each one of device 1700 and equipment 1701 or may be stand-alone units. An audio component of videos and other content displayed on display 1712 may be played through speakers (or headphones) of audio output equipment 1714. In some embodiments, audio may be distributed to a receiver (not shown), which processes and outputs the audio via speakers of audio output equipment 514. In some embodiments, for example, control circuitry 1704 is configured to provide audio cues to a user, or other audio feedback to a user, using speakers of audio output equipment 514. There may be a separate microphone 516 or audio output equipment 1714 may include a microphone configured to receive audio input such as voice commands or speech. For example, a user may speak letters or words that are received by the microphone and converted to text by control circuitry 1704. In a further example, a user may voice commands that are received by a microphone and recognized by control circuitry 1704. AR display device 1718 may be any suitable AR display device (e.g., an integrated head mountain display or AR display device connected to a system 1700). In some embodiments all elements of system 1700 may be places into housing of the AR display device 518. In some embodiments, AR display device 1718 comprises a camera (or a camera array) 1756. Video cameras 1756 may be integrated with the equipment or externally connected. One or more of cameras 1756 may be a digital camera comprising a charge-coupled device (CCD) and/or a complementary metal-oxide semiconductor (CMOS) image sensor. One or more of cameras 1756 may be an analog camera that converts to digital images via a video card. In some embodiments, one or more of cameras 1756 may be directed at an outside physical environment (e.g., two cameras may be pointed out to capture to parallax views of the physical environment) to detect location. In some embodiments, one or more of cameras 1756 may be pointed at user's eyes to measure their rotation to be used as biometric sensors. In some embodiments, AR display device 518 may comprise other biometric sensor or sensors to measure eye rotation (e.g., electrodes to measure eye muscle contractions).

One or more application whose functionality is described herein may be implemented using any suitable architecture. For example, such applications may be stand-alone applications wholly-implemented on each one of user equipment device 1700 and user equipment device 1701. In such an approach, instructions of the application may be stored locally (e.g., in storage 1708), and data for use by the application is downloaded on a periodic basis (e.g., from an out-of-band feed, from an Internet resource, or using another suitable approach). Control circuitry 1704 may retrieve instructions of the application from storage 1708 and process the instructions to provide functionality and preform any of the actions discussed herein. Based on the processed instructions, control circuitry 1704 may determine what action to perform when input is received from user input interface 1710. For example, movement of a cursor on a display up/down may be indicated by the processed instructions when user input interface 1710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, data for use by a thick or thin client implemented on each one of user equipment device 1700 and user equipment device 1701 may be retrieved on-demand by issuing requests to a server remote to each one of user equipment device 1700 and user equipment device 1701. For example, the remote server may store the instructions for the application in a storage device. The remote server may process the stored instructions using circuitry (e.g., control circuitry 1704) and generate the displays discussed above and below. The client device may receive the displays generated by the remote server and may display the content of the displays locally on device 1700. This way, the processing of the instructions is performed remotely by the server while the resulting displays (e.g., that may include text, a keyboard, or other visuals) are provided locally on device 1700. Device 1700 may receive inputs from the user via input interface 1710 and transmit those inputs to the remote server for processing and generating the corresponding displays. For example, device 1700 may transmit a communication to the remote server indicating that an up/down button was selected via input interface 1710. The remote server may process instructions in accordance with that input and generate a display of the application corresponding to the input (e.g., a display that moves a cursor up/down). The generated display is then transmitted to device 1700 for presentation to the user.

In some embodiments, an application whose functions are described herein may be downloaded and interpreted or otherwise run by an interpreter or virtual machine (run by control circuitry 1704). In some embodiments, such an application may be encoded in the ETV Binary Interchange Format (EBIF), received by control circuitry 1704 as part of a suitable feed, and interpreted by a user agent running on control circuitry 1704. For example, the application may be an EBIF application. In some embodiments, the application may be defined by a series of JAVA-based files that are received and run by a local virtual machine or other suitable middleware executed by control circuitry 1704. In some of such embodiments (e.g., those employing MPEG-2 or other digital media encoding schemes), the application may be, for example, encoded and transmitted in an MPEG-2 object carousel with the MPEG audio and video packets of a program.

FIG. 18 is a diagram of an illustrative system 1800 for in accordance with some embodiments of this disclosure. User equipment devices 1807, 18018, 1810 (e.g., which may correspond to one or more of computing device may be coupled to communication network 1806. Communication network 1806 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1806) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 18 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 1806.

System 1800 may comprise media content source 1802, one or more servers 1804, and one or more edge computing devices 1816. In some embodiments, the applications may be executed at one or more of control circuitry 1811 of server 1804 (and/or control circuitry of user equipment devices 1807, 18018, 1810 and/or control circuitry 1818 of edge computing device 1816).

In some embodiments, server 1804 may include control circuitry 1811 and storage 1814 (e.g., RAM, ROM, Hard Disk, Removable Disk, etc.). Storage 1814 may store one or more databases. Server 1804 may also include an input/output path 1812. I/O path 1812 may provide generation data, device information, or other data, over a local area network (LAN) or wide area network (WAN), and/or other content and data to control circuitry 1811, which may include processing circuitry, and storage 1814. Control circuitry 1811 may be used to send and receive commands, requests, and other suitable data using I/O path 1812, which may comprise I/O circuitry. I/O path 1812 may connect control circuitry 1811 (and specifically control circuitry) to one or more communications paths. One or more functions or features described herein as being provided by control circuitry 1811 may be performed by software modules, including processing module and I/O module that implement, respectively, functionality and features described as being implemented by processing circuitry and I/O circuitry.

Control circuitry 1811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1811 may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 1811 executes instructions for an emulation system application stored in memory (e.g., the storage 1814). Memory may be an electronic storage device provided as storage 1814 that is part of control circuitry 1811.

Edge computing device 1816 may comprise control circuitry 18118, I/O path 1820 and storage 1822, which may be implemented in a similar manner as control circuitry 1811, I/O path 1812 and storage 1824, respectively of server 1804. Edge computing device 1816 may be configured to be in communication with one or more of user equipment devices 1807, 18018, 1810 and video server 1804 over communication network 1806, and may be configured to perform processing tasks in connection with ongoing processing of video data. In some embodiments, a plurality of edge computing devices 1816 may be strategically located at various geographic locations, and may be mobile edge computing devices configured to provide processing support for mobile devices at various geographical regions.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

Unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not imply that the feature is necessary. Inclusion of the phrase “in some embodiments” does not imply that the feature is not applicable to other embodiments or even all embodiments. Throughout the specification, the phrases “in response to” and “based on” shall be understood to have a broad meaning unless context requires otherwise. For example, “in response to” may refer to a step that is in direct or indirect response to a prior step, and “based on” may refer to a step that is based at least in part on a prior step or on another factor.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

The systems and/or methods described above may be applied to, or used in accordance with, other systems and/or methods. In various embodiments, additional elements may be included, some elements may be removed, and/or elements may be arranged differently from what is shown. Alterations, modifications, combination, and variations may be made to the particular embodiments by those of skill in the art without departing from the scope of the present application, which is defined solely by the claims appended hereto.

1. A method comprising:
determining channel state information (CSI) of a communication link with a portable device, wherein the communication link is provided at least in part by a Wi-Fi Access Point (AP) associated with a first telecommunications network or a transceiver of a second telecommunications network;
based at least in part on the determined CSI, determining that the portable device is at an egress/ingress zone;
detecting a direction of movement of the portable device at or near the egress/ingress zone;
based at least in part on the detected direction of movement of the portable device and based at least in part on the determining that the portable device is at the egress/ingress zone, initiating an action for handoff of the portable device between the AP and the transceiver of the second telecommunications network.

2. The method of claim 1, further comprising:
determining that a received signal strength indicator (RSSI) of a signal received at or transmitted by the portable device is weakened, wherein the determining of the CSI of the communication link with the portable device is initiated based at least in part on the determining of the weakened signal strength.

3. The method of claim 1, further comprising:
determining that a quality of a networking related signal received at or transmitted by the portable device has deteriorated, wherein the determining of the CSI of the communication link with the portable device is initiated based at least in part on the determining of the deteriorated quality of networking related signal.

4. The method of claim 1, further comprising:
detecting a network traffic speed decrease at the portable device, wherein the determining of the CSI of the communication link with the portable device is initiated based at least in part on the determining of the network traffic speed decrease.

5. The method of claim 1, further comprising:
receiving an indication of a timeout metric or a lost application layer packet metric, wherein the determining of the CSI of the communication link with the portable device is initiated based at least in part on the received indication of the timeout metric or the lost application layer packet metric.

6. The method of claim 1, further comprising:
detecting a download speed at the portable device based at least in part on an adaptive bit rate (ABR) ladder setting, wherein the determining of the CSI of the communication link with the portable device is initiated based at least in part on the detected download speed at the portable device.

7. The method of claim 1, further comprising:
detecting a proximity of the portable device to a second device, wherein the determining of the CSI of the communication link with the portable device is initiated based at least in part on the detected proximity of the portable device to the second device.

8. The method of claim 1, further comprising:
mapping a plurality of physical locations in relation to the Wi-Fi local area network, wherein the determining of the CSI of the communication link with the portable device is initiated based at least in part on detecting that the portable device is in a first physical location of the plurality of physical locations.

9. The method of claim 1, wherein the determining that the portable device is at the egress/ingress zone comprises determining a CSI signature at a physical location of the portable device.

10. The method of claim 1, wherein the determining the CSI of the communication link with the portable device is performed by the AP of the Wi-Fi local area network.

11. The method of claim 1, wherein the second telecommunications network is a mobile network, and the determining the CSI of the communication link with the portable device is performed by a base station of the mobile telecommunications network.

12. The method of claim 1, wherein the direction of the movement of the portable device is determined based at least in part on the CSI.

13. The method of claim 1, further comprising:
detecting a position of the portable device based at least in part on inertial measurement unit data generated by the portable device, wherein the direction of the movement of the portable device is detected based at least in part on the detected position of the portable device.

14. The method of claim 1, wherein the initiating of the action for handoff comprises signaling a portable device traffic switch from the AP to the transceiver of the second telecommunications network.

15. The method of claim 1, wherein the initiating the action for handoff comprises switching off Wi-Fi communication for the portable device.

16. The method of claim 1, further comprising:
based at least in part on the detected direction of movement of the portable device and based at least in part on the determining that the portable device is at the egress/ingress zone, notifying a second portable device of the handoff.

17. The method of claim 1, wherein the herein the action for handoff comprises traffic steering, switching or splitting across networks.

18. The method of claim 1, further comprising:
based at least in part on determining that a second device has the direction of movement of the portable device, notifying the second portable device of the handoff.

19. A system comprising:
a memory; and
control circuitry configured to:
determine channel state information (CSI) of a communication link with a portable device and store the CSI in the memory, wherein the communication link is provided at least in part by a Wi-Fi Access Point (AP) associated with a first telecommunications network or a transceiver of a second telecommunications network;
based at least in part on the determined CSI, determine that the portable device is at an egress/ingress zone;
detect a direction of movement of the portable device at or near the egress/ingress zone; and
based at least in part on the detected direction of movement of the portable device and based at least in part on the determining that the portable device is at the egress/ingress zone, initiating an action for handoff of the portable device between the AP and the transceiver of the second telecommunications network.

20. The system of claim 19, wherein the control circuitry is configured to:
determine that a received signal strength indicator (RSSI) of a signal received at or transmitted by the portable device is weakened, wherein the determining of the CSI of the communication link with the portable device is initiated based at least in part on the determining of the weakened signal strength.

21-90. (canceled)
